(19) United States
(12) Patent Application Publication
(10) Pub. No.: US 2025/0216583 A1
(43) Pub. Date: Jul. 3, 2025

(54) OPTICAL STRUCTURE AND MANUFACTURING METHOD THEREOF, AND DISPLAY APPARATUS

(71) Applicants: Beijing Zitiao Network Technology Co., Ltd., Beijing (CN); Lemon Inc., Grand Cayman (KY)

(72) Inventors: Shaopeng ZHU, Beijing (CN); Ziyang ZHANG, Los Angeles, CA (US); Jian CHEN, Beijing (CN); Hanning YANG, Beijing (CN); Hsin-Yi HU, Beijing (CN); Wenbin BAI, Beijing (CN)

(21) Appl. No.: 18/991,305

(22) Filed: Dec. 20, 2024

(30) Foreign Application Priority Data
Dec. 28, 2023 (CN) 202311841450.9

(51) Int. Cl. G02B 1/14; G02B 1/11

(52) U.S. Cl. CPC G02B 1/14; G02B 1/11

(57) ABSTRACT

An optical structure and a manufacturing method thereof, and a display apparatus are provided. The optical structure includes an optical element and a light-transmitting protective film. The optical element includes a first surface and a second surface. The light-transmitting protective film is between the optical element and air, and is in contact with the optical element. The optical element includes a lens structure including a first lens surface and a second lens surface, a transflective film, a reflective polarizing film, and a phase retardation film. The light-transmitting protective film includes a first structure and a second structure in contact with air, the compactness of the first structure is greater than that of the second structure, the second structure includes microstructures having a pitch not greater than a working wavelength of the optical element.

The present application claims priority to Chinese Patent Application No. 2023118414509, filed on Dec. 28, 2023, the disclosure of which is incorporated herein in its entirety as part of the present application.

### TECHNICAL FIELD

The embodiments of the present disclosure relate to an optical structure and a manufacturing method thereof, and a display apparatus.

### BACKGROUND

Optical elements, such as optical lens groups, optical waveguides, and prisms, may include multiple elements such as micro-nano structures, optical resins, optical films, optical adhesives, and optical coatings, as well as various materials such as organic polymers, organic small molecules, metals, and inorganic non-metals to meet specific and complex optical requirements. In optical elements, characteristics such as the high water absorption rate of certain optical resins (such as polymethyl methacrylate, PMMA), the fogging or degumming phenomenon of certain optical adhesives or resins when exposed to water vapor, the formation of bubbles due to outgassing in high temperature and high humidity environments, and the corrosion characteristics of metal materials in certain coating materials and small molecular materials in film materials when exposed to water vapor and oxygen are all closely related to water vapor and oxygen in the external environment. Therefore, isolating the external moisture and oxygen environment is an important way to improve the reliability of optical elements.

### SUMMARY

The present disclosure provides an optical structure and a manufacturing method thereof, and a display apparatus.

The present disclosure provides an optical structure, which includes an optical element and a light-transmitting protective film. The optical element includes a first surface and a second surface opposite to each other; the light-transmitting protective film is between the optical element and air, and the light-transmitting protective film is at least in contact with at least one of the first surface and second surface. The optical element includes a lens structure and a transflective film, a reflective polarizing film, and a phase retardation film provided on the lens structure, the lens structure includes a first lens surface and a second lens surface respectively provided on a light incident side and a light exiting side of the lens structure, at least one of the first lens surface and the second lens surface is a curved surface, both the reflective polarizing film and the phase retardation film are provided on a side of the transflective film facing the second lens surface, the first surface and the second surface include at least one of the group consisting of a surface of the transflective film, a surface of the phase retardation film, a surface of the reflective polarizing film, the first lens surface and the second lens surface; the light-transmitting protective film includes a first structure and a second structure stacked with each other, the second structure is in contact with the air, and the first structure is in contact with the optical element, a compactness of the first structure is greater than a compactness of the second structure, the second structure includes a plurality of microstructures, and at least part of the microstructures have a pitch of a feature size in a direction parallel to a surface, of the first structure, in contact with the optical element, and the feature size is not greater than a working wavelength of the optical element.

For example, according to an embodiment of the present disclosure, a water vapor transmission rate of the first structure is ≤1 g·mm/(m²·24 h).

For example, according to an embodiment of the present disclosure, the feature size is 10 nm to 300 nm.

For example, according to an embodiment of the present disclosure, an average thickness of the light-transmitting protective film is 50 nm to 10 μm.

For example, according to an embodiment of the present disclosure, an average thickness of the second structure is 20 nm to 300 nm.

For example, according to an embodiment of the present disclosure, a refractive index of the first structure is greater than an equivalent refractive index of the second structure, and the refractive index of the first structure is 1.4 to 2.5, and the equivalent refractive index of the second structure gradually decreases in an arrangement direction of the first structure towards the second structure.

For example, according to an embodiment of the present disclosure, a size of each microstructure in a direction parallel to the surface of the first structure in contact with the optical element is a cross-sectional size, and in the arrangement direction, the at least a part of the microstructures have decreasing cross-sectional sizes.

For example, according to an embodiment of the present disclosure, the at least part of the microstructures have a shape of a circular truncated cone or a cone.

For example, according to an embodiment of the present disclosure, a material of the light-transmitting protective film includes one or more of parylene and its various substituted derivatives, hexamethyldisiloxane, polytetrafluoroethylene, acrylic acids, and fluorosilanes.

For example, according to an embodiment of the present disclosure, the second structure in the light-transmitting protective film is configured to have a reflectivity to visible light of lower than 0.2%.

For example, according to an embodiment of the present disclosure, the light-transmitting protective film completely encloses the optical element.

For example, according to an embodiment of the present disclosure, the first structure and the second structure are integrally arranged.

For example, according to an embodiment of the present disclosure, the optical structure further includes: a linear polarizing film, on a side of the reflective polarizing film away from the transflective film.

For example, according to an embodiment of the present disclosure, the second surface includes a surface of the linear polarizing film.

For example, according to an embodiment of the present disclosure, an average thickness of the first structure is greater than the average thickness of the second structure.

The present disclosure provides a display apparatus, which includes a display screen and the optical structure as mentioned above, the optical structure is provided on a display side of the display screen, and the second surface is provided on a side of the first surface away from the display screen.

The present disclosure provides a method for manufacturing the optical structure as mentioned above, which includes forming the plurality of microstructures in the light-transmitting protective film through plasma etching.

### BRIEF DESCRIPTION OF DRAWINGS

In order to more clearly illustrate the technical solutions of the embodiments of the present disclosure, the accompanying drawings of the embodiments will be briefly introduced below, it is obvious that the accompanying drawings in the following description merely relate to some embodiments of the present disclosure, but not the limitations of the present disclosure.

FIG. 1 is a cross-sectional schematic of an optical structure provided in an example according to an embodiment of the present disclosure.

FIG. 2 is an enlarged diagram of the region A show in FIG. 1.

FIG. 3 is a cross-sectional schematic of an optical structure provided in another example according to an embodiment of the present disclosure.

FIG. 4 is a structural cross-sectional schematic of a part of a display apparatus provided in another embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects.

The features “parallel”, “perpendicular” and “same” used in the embodiments of the present disclosure all include features such as “parallel”, “perpendicular” and “same” in the strict sense, and the cases having certain errors, such as “approximately parallel”, “approximately perpendicular”, “approximately the same” or the like, taking into account measurements and errors associated with the measurement of a particular quantity (e.g., limitations of the measurement system), and indicate being within an acceptable range of deviation for a particular value as determined by one of ordinary skill in the art. For example, “approximately” may indicate being within one or more standard deviations, or within 10% or 5% of the stated value. In the case that the quantity of a component is not specifically indicated below in the embodiments of the present disclosure, it means that the component may be one or more, or may be understood as at least one. “At least one” means one or more, and “plurality” means at least two.

In general, an element exposed to air may be isolated from moisture and oxygen through methods such as forming a conformal coating on the surface of the element, such as coating or plating at least one dense coating/plating layer on the surface of the element to block the external moisture and oxygen. At present, conformal coatings are used for the external surface waterproofing of circuit boards, chips, microelectromechanical systems (MEMS), magnetic cores, sensors, optical fibers or mobile phones in the electronics industry. For example, the conformal coatings include coatings such as parylene, hexamethyldisiloxane (HMDSO), polytetrafluoroethylene (PTFE), fluorosilanes and other coatings plated by chemical vapor deposition (CVD), or three-proof coatings such as acrylic, polyurethane, organosilicon and other coatings applied by solution method.

An optical element applied in the field of virtual reality (VR) includes a structure with a short-focus folded optical path (pancake). For example, it includes a plurality of lenses made of optical resins, organic and inorganic optical coatings and platings applied on the surfaces of the lenses, polymer films attached to the surfaces of the lenses through optically clear adhesives (OCA) or pressure-sensitive adhesives (PSA), such as reflective polarizing film, phase retardation film, liquid crystal compensation film, linear polarizing film, anti-reflective film, or the like, and optical clear resin (OCR) for gluing multiple lenses.

The optical element may be isolated from a moisture and oxygen environment by several methods. However, an optical element with the foregoing pancake structure needs to face both the human eyes and the display screen, with air around the optical element, so it cannot be completely sealed in the packaging mechanism. In addition, for a foregoing precision optical element with pancake structure, plating the foregoing coating directly on the optical surface generally significantly changes the optical properties of the optical element. Even if the element is first plated with the above coating and then applied with an anti-reflective film, the original optical performance of the optical element cannot be maintained because there is still an optical interface with a sudden change between the conventional anti-reflective film and the coating.

The inventor of the present application found out through study that a conventional anti-reflective coating with multiple film layers has limited anti-reflective effect. In particular, the anti-reflective coatings on the polymers commonly used in resin lenses and protective coatings have limited number of layers and materials, which may not offset the interferences of new surfaces of the protective coatings on the performance of optical element. To maintain the original optical performance when an additional protective coating is added to the forgoing optical element with pancake structure, or an optical element including multi-piece lens groups, the surface thereof has higher requirement for the anti-reflective effect, which at present may be met by a structural anti-reflection method and a moth-eye anti-reflection. The structural anti-reflection method includes a sub-wavelength structural coating (SWC), where a hydrolyzable film layer, such as alumina, may be deposited on an optical element through atomic layer deposition (ALD) or physical vapor deposition (PVD), and then the optical element with the foregoing deposited film layer is put into water or related solvents to hydrolyze the film into a loose and porous structure, so that the film layer is formed into a suitable film layer with a low refractive index or gradient refractive index to achieve a better anti-reflective effect. The structural anti-reflection method may already been implemented in mass production, but with limited yield, production capacity, and cost, and because of the hydrolysis process, the optical element may be corroded, which is in conflict with the technical problem to be solved in the present application The moth-eye anti-reflection method may use the roll-to-roll nanoimprint lithography technique to form an anti-reflective structure on a transparent plastic foil, and then attach the plastic foil to the surface of the lens. However, this method cannot meet the anti-reflection needs of lens surfaces with large curvatures, and the high cost may bring new reliability risks.

Therefore, both of the above two anti-reflection methods might not be able to remedy the deteriorated optical properties of an optical element with pancake structure to which a protective conformal coating is added.

The embodiments of the present disclosure provide an optical structure and a manufacturing method thereof, and a display apparatus. The optical structure includes an optical element and a light-transmitting protective film. The optical element includes a first surface and a second surface opposite to each other. The light-transmitting protective film is provided between the optical element and air, and the light-transmitting protective film is at least in contact with at least one of the first surface and second surface. The optical element includes a lens structure and a transflective film, a reflective polarizing film, and a phase retardation film provided on the lens structure. The lens structure includes a first lens surface and a second lens surface respectively provided on a light incident side and a light exiting side of the lens structure, at least one of the first lens surface and the second lens surface is a curved surface. Both the reflective polarizing film and the phase retardation film are provided on a side of the transflective film facing the second lens surface. The first surface and the second surface include at least one of the group consisting of a surface of the transflective film, a surface of the phase retardation film, a surface of the reflective polarizing film, the first lens surface and the second lens surface. The light-transmitting protective film includes a first structure and a second structure stacked with each other, the second structure is exposed to air, and the first structure is in contact with the optical element, the compactness of the first structure is greater than the compactness of the second structure, the second structure includes a plurality of microstructures, and at least part of the microstructures have a pitch of a feature size in the direction parallel to a surface of the first structure in contact with the optical element, and the feature size is not greater than the working wavelength of the optical element.

In the optical structure provided in the present disclosure, a light-transmitting protective film is at least provided on at least one of the first surface and the second surface of the optical element including the lens structure, the transflective film, the reflective polarizing film and the phase retardation film, and the second structure of the light-transmitting protective film exposed to air includes a microstructure with a feature size not greater than the working wavelength, such that the optical element sensitive to the environment is isolated from external moisture and oxygen by the light-transmitting protective film, and the optical properties of the optical element are not deteriorated due to the addition of the light-transmitting protective film, and the light-transmitting protective film has anti-reflection performance.

The optical structure and the manufacturing method thereof, and the display apparatus provided in the present disclosure are described below with reference to the accompanying drawings.

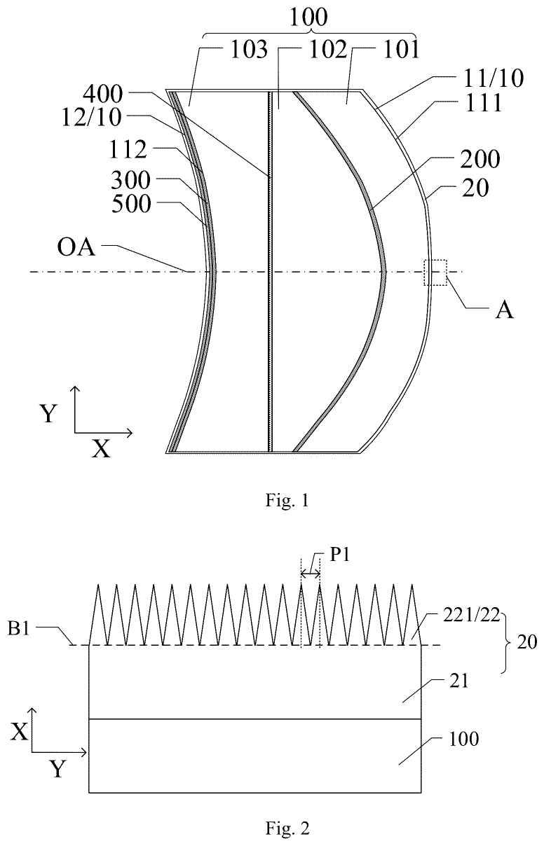

FIG. 1 is a cross-sectional schematic of an optical structure provided in an example according to the embodiments of the present disclosure. FIG. 2 is an enlarged diagram of the region A show in FIG. 1.

As shown in FIG. 1, the optical structure includes an optical element 10 and a light-transmitting protective film 20. The optical element 10 includes a first surface 11 and a second surface 12 opposite to each other. The light-transmitting protective film 20 is provided between the optical element 10 and air, and the light-transmitting protective film 20 is at least in contact with at least one of the first surface 11 and second surface 12. For example, the light-transmitting protective film 20 is configured to protect at least part of the structure of the optical element 10. For example, a surface of the light-transmitting protective film 20 away from the optical element 10 may be exposed to air.

As shown in FIG. 1, the optical element 10 includes a lens structure 100 and a transflective film 200, a reflective polarizing film 300, and a phase retardation film 400 provided on the lens structure 100, the lens structure 100 includes a first lens surface 111 and a second lens surface 112 respectively provided on a light incident side and a light exiting side of the lens structure, and at least one of the first lens surface 111 and the second lens surface 112 is a curved surface.

For example, as shown in FIG. 1, the first lens surface 111 and the second lens surface 112 are two oppositely arranged surfaces on the outermost side of the lens structure 100. For example, the lens structure 100 may include at least one lens, such as an optic lens, and the first lens surface 111 and the second lens surface 112 may be two surfaces of the same lens or may be surfaces of different lenses. For example, both the first lens surface 111 and the second lens surface 112 may be curved surfaces. For example, the first lens surface 111 can be convex and the second lens surface 112 may be concave. However, the present disclosure is not limited thereto, and only one of the first lens surface 111 and the second lens surface 112 may be a curved surface. For example, at least one of the first lens surface 111 and the second lens surface 112 may be spherical, aspherical, or freeform. For example, at least one of the first lens surface 111 and the second lens surface 112 may have a radius of curvature of not greater than 20 mm.

As shown in FIG. 1, the reflective polarizing film 300 and the phase retardation film 400 are both provided on a side of the transflective film 200 facing the second lens surface 112. For example, the reflective polarizing film 300 is provided on a side of the phase retardation film 400 away from the transflective film 200. Of course, the embodiments of the present disclosure are not limited thereto, and the relative positional relationship of the reflective polarizing film 300 with respect to the phase retardation film 400 may be set according to different material selections.

In some examples, as shown in FIG. 1, the optical structure further includes a linear polarizing film 500 provided on a side of the reflective polarizing film 300 away from the transflective film 200.

For example, as shown in FIG. 1, the lens structure 100 includes three lenses. For example, the lens structure 100 includes a lens 101, a lens 102 and a lens 103 sequentially arranged in the direction parallel to an optical axis OA of the lens structure 100 (the X direction as shown in FIG. 1), a surface of the lens 101 away from the lens 102 may be the first lens surface 111, a surface of the lens 103 away from the lens 102 may be the second lens surface 112, and the adjacent lenses are glued together through an optical clear resin (OCR). For example, the first lens surface 111 may be convex, the lens surface of the lens 101 facing the lens 102 may be concave, and the lens surface of the lens 102 facing the lens 101 may be convex. The two lens surfaces are substantially of the same face type. The lens surface of the lens 102 away from the lens 101 may be flat, and the lens surface of the lens 103 facing the lens 102 may be flat. The second lens surface 112 may be concave. For example, the first surface 11 and the second surface 12 of the optical element 10 are arranged in a direction parallel to the optical axis OA.

For example, as shown in FIG. 1, the transflective film 200 may be referred to as a semi-transmissive semi-reflective film coated on the surface of the lens 102 facing the lens 101. For example, the phase retardation film 400 may be attached between the lens 102 and the lens 103, and a liquid crystal compensation film may also be provided between the lens 102 and the lens 103. For example, the phase retardation film 400 and the liquid crystal compensation film are attached between the lens 102 and the lens 103 by pressure sensitive adhesive (PSA). For example, the reflective polarizing film 300 and the linear polarizing film 500 are attached to the second lens surface 112 on a side of the lens 103 away from the lens 102. For example, the reflective polarizing film 300 is attached to the second lens surface 112 through an optically clear adhesive (OCA).

For example, as shown in FIG. 1, the lens structure 100 includes a plurality of lenses with zero phase difference. For example, the lens 101, the lens 102, and the lens 103 have zero phase difference, and are made of, for example, acrylic materials (PMMA).

For example, as shown in FIG. 1, the transflective film 200 is configured to transmit a part of light and reflect another part of light. For example, the transflective film 200 may include at least one layer. For example, each layer may have a thickness of 10 nm to 200 nm. For example, the transflective film 200 may have a transmittance of 50% and a reflectance of 50%. For example, the transflective film 200 may have a transmittance of 60% and a reflectance of 40%. For example, the transflective film 200 may have a transmittance of 65% and a reflectance of 35%. The optical structure provided in the present disclosure is not limited thereto, and the transmittance and reflectance of the transflective film 200 may be set according to the product requirements. For example, to apply the transflective film 200, a polysiloxane primer may be first applied on the convex surface of the lens 102 by spin coating or dip coating, and then the metal-containing transflective film 200 may be applied through ion-assisted evaporation coating. For example, the transflective film 200 includes a metallic layer and at least one non-metallic layer that are stacked with each other. For example, there are multiple of the at least one non-metallic layer, and these layers are provided on either side of the metallic layer. For example, the transflective film 200 may include stacked layers of titanium dioxide (TiO₂), silver (Ag), titanium dioxide (TiO₂), silicon dioxide (SiO₂), and titanium dioxide (TiO₂). For example, the stacked layers of titanium dioxide, silver, titanium dioxide, silicon dioxide, and titanium dioxide may have a thickness of 29.7 nm, 18.2 nm, 1.5 nm, 16.1 nm, and 68.6 nm, respectively.

For example, as shown in FIG. 1, the reflective polarizing film 300 is configured to reflect linearly polarized light with one characteristic and transmit linearly polarized light with another characteristic.

For example, as shown in FIG. 1, the reflective polarizing film 300 has the following features: in a transmission axis on the film layer plane, the transmittance of the polarization component of the incident light (for example, s-line polarized light) parallel to the direction of the transmission axis is greater than that of the polarization component (for example, p-line polarized light) perpendicular to the direction of the transmission axis, and the reflectance of the polarization component (for example, s-line polarized light) parallel to the direction of the transmission axis is lower than that of the polarization component (for example, p-line polarized light) perpendicular to the direction of the transmission axis. For example, the reflective polarizing film 300 may also be referred to as a polarizing beam-splitting film. For example, the transmittance of the polarized light parallel to the transmittance axis of the reflective polarizing film 300 is not lower than 85%, for example, not lower than 90%, for example, not lower than 95%, and for example, not lower than 98%. The reflectance of the polarized light perpendicular to the transmittance axis of the reflective polarizing film 300 is not lower than 85%, for example, not lower than 90%, for example, not lower than 95%, and for example, not lower than 98%. For example, the reflective polarizing film 300 may include a multiple layers of reflective polarizing film, a metal wire grid polarizer (WGF), or the like.

For example, as shown in FIG. 1, the phase retardation film 400 is configured to enable the transmitted light to transfer between a circularly polarized state and a linearly polarized state. For example, the phase retardation film 400 may be a quarter-wave plate. For example, the phase retardation film 400 may be made of liquid crystal polymer or polycarbonate. For example, the phase retardation film 400 has the following features: in a direction with the lowest refractive index and a direction with the highest refractive index in the film layer plane, which are a fast axis and a slow axis, respectively, the polarized light parallel to the slow axis is delayed by a quarter wave after passing through the phase retardation film 400 than the polarized light parallel to the fast axis after passing through the phase retardation film 400.

For example, as shown in FIG. 1, the slow axis of the phase retardation film 400 has an included angle of 45 degrees relative to the transmission axis of the reflective polarizing film 300.

For example, as shown in FIG. 1, the transmittance axis of the linear polarizing film 500 coincides with the transmittance axis of the reflective polarizing film 300. For example, the linear polarizing film 500 may be used to further filter other stray light, allowing only the polarized light (such as the s-line polarized light) passing through the linear polarizing film 500 to reach a human eye. For example, the linear polarizing film 500 may be referred to as a polarizer including a cellulose triacetate (TAC) film and a stretched iodine-doped polyvinyl alcohol (PVA) film, which is bonded to the reflective polarizing film 300 through a PSA.

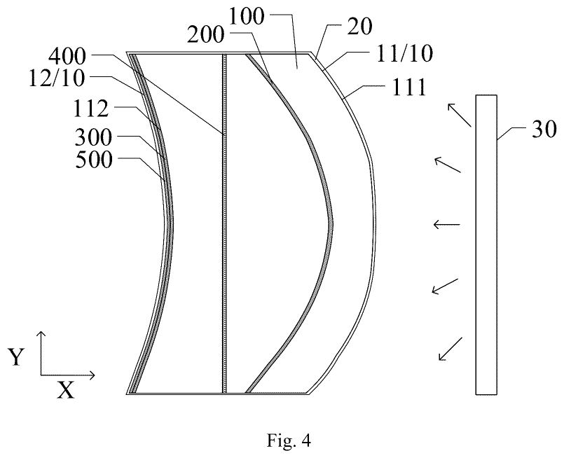

For example, as shown in FIG. 1, the display screen (not shown in FIG. 1, combined with a display 30 in FIG. 4) may be located on a side of the transflective film 200 away from the phase retardation film 400. Light rays, such as the light rays emitted from the display screen and incident on the lens structure 100 through the transflective film 200, are configured to turn back between the transflective film 200 and the reflective polarizing film 300, and exit from the reflective polarizing film 300 to achieve an ultra-short-focus folded optical path (Pancake). For example, the image light emitted by the display screen 30 enters the lens structure 100 after passing through the first lens surface 111 on the light incident side of the lens structure 100, turns back, and exits from the second lens surface 112 on the light exiting side of the lens structure 100.

For example, as shown in FIG. 1, a folded optical path has the following working principle. The light incident side of the display screen 30 may be provided with a wave plate, and the image light emitted from the display screen 30 is converted into right-handed circularly polarized light after passing through the wave plate, and the right-handed circularly polarized light is then incident on the transflective film 200, and remains an unchanged status after being transmitted by the transflective film 200. The right-handed circularly polarized light reaches the phase retardation film 400, and the right-handed circularly polarized light incident on the phase retardation film 400 is converted into p-line polarized light, and the p-line polarized light is reflected back to the phase retardation film 400 by the reflective polarizing film 300, where the first reflection occurs. Then, the p-line polarized light is converted into the right-handed circularly polarized light after passing through the phase retardation film 400, and the right-handed circularly polarized light reaches the transflective film 200 and is reflected at the transflective film 200, where the second reflection occurs. The reflected light changes from right-handed circularly polarized light to left-handed circularly polarized light. The left-handed circularly polarized light is converted into s-line polarized light through the phase retardation film, and then the s-line polarized light is transmitted to a human eye through the reflective polarizing film 300 and the linear polarizing film 500.

The folded optical path may change the polarization state of the light propagating between the reflective polarizing film 300 and the transflective film 200, thereby folding the light, so that the original focal length of the optical element 10 is folded because of the for example two reflections that are increased by providing the foregoing reflective polarizing film 300, the phase retardation film 400, and the transflective film 200, thereby greatly compressing the space required between the human eye and the optical structure, which further decreases the size and weight of the optical element 10.

As shown in FIG. 1, the first surface 11 and the second surface 12 of the optical element 10 include at least one of a surface of the transflective film 200, a surface of the phase retardation film 400, a surface of the reflective polarizing film 300, the first lens surface 111 and the second lens surface 112. For example, the first surface 11 and the second surface 12 of the optical element 10 include at least one of a surface of the transflective film 200, a surface of the phase retardation film 400, a surface of the reflective polarizing film 300, a surface of the linear polarizing film 500, the first lens surface 111, and the second lens surface 112. For example, FIG. 1 schematically shows that the first surface 11 of the optical element 10 is the first lens surface 111 of the lens structure 100.

In some examples, as shown in FIG. 1, the second surface 12 of the optical element 10 includes a surface of the linear polarizing film 500.

As shown in FIG. 1 and FIG. 2, the light-transmitting protective film 20 includes the first structure 21 and the second structure 22 stacked with each other. The second structure 22 is exposed to air, the first structure 21 is in contact with the optical element 10, and the compactness of the first structure 21 is greater than that of the second structure 22. The second structure 22 includes a plurality of microstructures 221, where at least a part of the microstructures 221 has a pitch P1 of a feature size in the direction parallel to a surface of the first structure 21 in contact with the optical element 10, and the feature size is not greater than the working wavelength of the optical element 10.

When the optical element 10 provided in the embodiments of the present disclosure is not protected by the light-transmitting protective film 20, the foregoing lens structure 100 made of PMMA has a high water absorption rate, so that under high temperature and high humidity conditions, water absorption will cause the failure between the lens and the coating film in the lens structure 100. The silver in the foregoing transflective film 200 is very susceptible to corrosion by the external moisture and oxygen environment. The PVA in the foregoing linear polarizing film 500 tends to absorb moisture, while the moisture tends to interfere with the molecular arrangement and the reaction with iodine molecules, leading to material failure. The above OCA, PSA, and OCR may fog due to condensation after being saturated with water absorption under high temperature and high humidity conditions, or generate bubbles due to reasons such as gas release from water absorption.

In the optical structure provided in the present disclosure, the light-transmitting protective film 20 is at least provided on at least one of the first surface 11 and the second surface 12 of the optical element 10 including the lens structure 100, the transflective film 200, the reflective polarizing film 300 and the phase retardation film 400, and the second structure 22 of the light-transmitting protective film 20 exposed to air includes a microstructure 221 with the feature size not greater than the working wavelength, such that the optical element 10 sensitive to the environment is isolated from external moisture and oxygen by the light-transmitting protective film 20, and the optical properties of the optical element are not affected due to the addition of the light-transmitting protective film, and the light-transmitting protective film has anti-reflection performance.

For example, the compactness refers to the air content in a substance. The higher the air content in the substance, the lower the compactness. The lower the air content in the substance, the higher the compactness. For example, the compactness of the first structure 21 is greater than that of the second structure 22, which may indicate that the air content in the first structure 21 is lower than that in the second structure 22.

For example, as shown in FIG. 2, the first structure 21 may be referred to as a continuous dense structure, and the second structure 22 may be referred to as a discontinuous structure. For example, air is provided between adjacent microstructures 221 in the cross-section from which the discontinuous structure is cut out by a plane parallel to the first surface 11. By providing the first structure 21 as a continuous dense structure, the light-transmitting protective film 20 may be isolated from moisture and oxygen.

In some examples, as shown in FIG. 2, the water vapor transmission rate (WVTR) of the first structure 21 is ≤1 g mm/(m²·24 h). For example, the water vapor transmission rate of the second structure 22 is greater than that of the first structure 21. The 1 g·mm/(m²·24 h) indicates the mass of water vapor transmitted per unit area and unit thickness of the first structure 21 per unit time period under specific conditions (temperature, humidity, and the like). For example, less than 1 g water vapor is allowed to be transmitted by the first structure 21 having an area of one square meter and a thickness of 1 mm in 24 hours.

For example, as shown in FIG. 2, the water vapor transmission rate of the first structure 21 is ≤0.9 g·mm/(m²·24 h). For example, the water vapor transmission rate of the first structure 21 is ≤0.8 g·mm/(m²·24 h). For example, the water vapor transmission rate of the first structure 21 is ≤0.7 g·mm/(m²·24 h). For example, the water vapor transmission rate of the first structure 21 is ≤0.6 g·mm/(m²·24 h). For example, the water vapor transmission rate of the first structure 21 is ≤0.5 g·mm/(m²·24 h). For example, the water vapor transmission rate of the first structure 21 is ≤0.4 g·mm/(m²·24 h). For example, the water vapor transmission rate of the first structure 21 is ≤0.3 g·mm/(m²·24 h). For example, the water vapor transmission rate of the first structure 21 is ≤0.2 g·mm/(m²·24 h). For example, the water vapor transmission rate of the first structure 21 is ≤0.1 g·mm/(m²·24 h). For example, the water vapor transmission rate of the first structure 21 is ≤0.09 g·mm/(m². 24 h). For example, the water vapor transmission rate of the first structure 21 is ≤0.08 g·mm/(m²·24 h).

In some examples, as shown in FIG. 1, the light-transmitting protective film 20 completely encloses the optical element 10. For example, the light-transmitting protective film 20 is in contact with the outer surface at various positions of the optical element 10. For example, in addition to the first surface 11 and the second surface 12 opposite to each other, the optical element 10 further includes other surfaces located therebetween, such as a surface parallel to the optical axis OA, such as a circumferential contour surface of the lens 101, a circumferential contour surface of the lens 102, and a circumferential contour surface of the lens 103, where the light-transmitting protective film 20 encloses the three circumferential contour surfaces. The light-transmitting protective film 20 completely encloses the optical element 10, thereby completely isolating the optical element 10 from the external moisture and oxygen, preventing the failure of the optical element 10 due to moisture absorbed by the material of the lens structure 100, the silver in the transflective film 200, and the PVA, OCA, PSA, and the OCR in the linear polarizing film 500.

For example, FIG. 2 schematically shows a cross-sectional diagram of a plurality of microstructures 221 included in the second structure 22. For example, the plurality of microstructures 221 may be arranged in an array along the first surface 11 of the optical element 10. For example, the plurality of microstructures 221 may be equally spaced by an interval. However, the present disclosure is not limited thereto, and the spacing of the microstructures 221 at different positions may also be adjusted according to the imaging region of the optical element 10.

For example, as shown in FIG. 2, the pitch P1 of the plurality of microstructures 221 in the direction parallel to the surface of the first structure 21 in contact with the optical element 10 is the feature size. For example, the above pitch P1 may be the distance between the centerlines of two adjacent microstructures 221. For example, the pitch P1 may be the distance between the midpoints of the bottom surfaces of two adjacent microstructures 221 closest to the first structure 21 (the plane where the dividing line B1 between the first structure 21 and the second structure 22 is located, as shown in FIG. 2).

In some examples, as shown in FIG. 2, the feature size is 10 nm to 300 nm. For example, the feature size is 12 nm to 280 nm. For example, the feature size is 15 nm to 250 nm. For example, the feature size is 20 nm to 220 nm. For example, the feature size is 25 nm to 200 nm. For example, the feature size is 30 nm to 170 nm. For example, the feature size is 35 nm to 150 nm. For example, the feature size is 40 nm to 120 nm. For example, the feature size is 50 nm to 100 nm. For example, the feature size is 55 nm to 80 nm. For example, the feature size is 60 nm to 70 nm. For example, the feature size is 65 nm to 155 nm. For example, the feature size is 45 nm to 180 nm. For example, the feature size is 75 nm to 160 nm. For example, the feature size is 85 nm to 270 nm. For example, the feature size is 110 nm to 260 nm. For example, the feature size is 120 nm to 240 nm.

It should be noted that the feature size is small, and even if the surface of the first structure 21 in contact with the optical element 10 is a curved surface, the direction parallel to the surface of the first structure 21 in contact with the optical element 10 may still be in the straight direction, such as the Y direction as shown in FIG. 2.

For example, the working wavelength at least includes the wavelength of the wave band of visible light. For example, the working wavelength includes the wavelength of the wave band of visible light and the wavelength of the wave band of infrared light. For example, the working wavelength may include the wavelength of the wave band of near infrared light. For example, the working wavelength may be 380 nm to 1050 nm. For example, the working wavelength may be 400 nm to 800 nm.

In some examples, as shown in FIG. 1 and FIG. 2, the light-transmitting protective film 20 is made of materials including one or more of parylene and its various substituted derivatives, hexamethyldisiloxane (HMDSO), polytetrafluoroethylene (PTFE), acrylic acids, fluorosilanes or the like. For example, the light-transmitting protective film 20 is made of materials including Parylene C with a thickness of 500 nm, where the water vapor transmission rate of the first structure 21 is 0.08 g·mm/(m²·24 h). For example, the light-transmitting protective film 20 may be formed on the optical element 10 by methods such as chemical vapor deposition, physical vapor deposition, or wet coating.

For example, as shown in FIG. 2, the first structure 21 and the second structure 22 may be made of the same material. However, the present disclosure is not limited thereto, and the first structure 21 and the second structure 22 may also be formed with different materials.

In some examples, as shown in FIG. 2, the first structure 21 and the second structure 22 are integrated structures. The second structure 22 with the microstructures 221 is formed by first forming a light-transmitting material layer on the optical element 10, and then patterning part of the thickness of the light-transmitting material layer.

In some examples, as shown in FIG. 1 and FIG. 2, the average thickness of the light-transmitting protective film 20 is 50 nm to 10 μm. The average thickness of the light-transmitting protective film 20 may be any value from 50 nm to 10 μm, for example, 70 nm, 7 μm, 8 μm, 100 nm or 5 μm, or the like, which is not limited in the embodiments of the present disclosure.

In some examples, as shown in FIG. 2, the average thickness of the second structure 22 is 20 nm to 300 nm. The average thickness of the second structure 22 may be any value from 20 nm to 300 nm, for example, 25 nm, 280 nm, 30 nm or 270 nm, or the like, which is not limited in the embodiments of the present disclosure.

For example, as shown in FIG. 2, the average thickness of the first structure 21 is greater than that of the second structure 22, providing better protection from moisture and oxygen for the optical element 10. Of course, the embodiments of the present disclosure are not limited thereto, and the average thickness of the first structure 21 may be lower than the average thickness of the second structure 22.

For example, as shown in FIG. 2, the average thickness of the light-transmitting protective film 20 is 500 nm, the average thickness of the second structure 22 is 120 nm, and the average thickness of the first structure 21 is 380 nm.

In some examples, as shown in FIG. 2, a size of each microstructure 221 in the direction parallel to the surface of the first structure 21 in contact with the optical element 10 is a cross-sectional size, and in the direction of the first structure 21 towards the second structure 22, at least a part of the microstructures 221 have decreasing cross-sectional sizes. By shaping the microstructure 221, the effective refractive index of the second structure 22 may be adjusted to a value between the refractive index of the first structure 21 and that of air, so as to reduce the reflectance of the light-transmitting protective film 20, providing the anti-reflection effect that is difficult to achieve by a general anti-reflection film.

For example, as shown in FIG. 2, the area of the cross-section of each microstructure 221 cut out by a plane parallel to the first lens surface 111 decreases in the direction of the first structure 21 towards to the second structure 22.

The direction of the first structure 21 towards the second structure 22 may include a direction perpendicular to the first lens surface 111, such as the normal direction of the first lens surface 111, such as including a direction parallel to the optical axis of the lens structure 100.

In some examples, as shown in FIG. 2, at least part of the microstructures 221 have a shape of a circular truncated cone or a cone. For example, each microstructure 221 has the same shape, such as a circular truncated cone or a cone.

FIG. 2 schematically shows that the microstructure 221 has the shape of a cone. For example, the microstructure 221 has a cross-sectional shape of a triangle. For example, the triangle may be an isosceles triangle. Of course, the embodiments of the present disclosure are not limited thereto, and when the microstructure 221 has a shape of a circular truncated cone, the cross-section of the microstructure 221 may have a shape of a trapezoidal, such as an isosceles trapezoid. For example, the cross-section of the microstructure may have a side edge of a straight line as shown in FIG. 2 or of a curve, which is not limited in the embodiments of the present disclosure.

In some examples, as shown in FIG. 2, the refractive index of the first structure 21 is greater than the equivalent refractive index of the second structure 22, and the refractive index of the first structure 21 is 1.4 to 2.5, and the equivalent refractive index of the second structure 22 gradually decreases in the direction of the first structure 21 towards the second structure 22. For example, the equivalent refractive index of the second structure 22 ranges from 1.1 to 1.4. For example, the equivalent refractive index of the second structure 22 ranges from 1.2 to 1.3.

When the feature size of the microstructure 221 is substantially smaller than the working wavelength of the optical structure, the second structure 22 may be regarded as a mixture of the film-forming material of the light-transmitting protective film 20 and air, and the equivalent refractive index of the second structure 22 is between the refractive index of the first structure 21 and the refractive index of air.

In some examples, as shown in FIG. 2, the second structure 22 in the light-transmitting protective film 20 is configured to have a reflectance to visible light of lower than 0.2%. For example, the second structure 22 is configured to have a reflectance to visible light of lower than 0.1%. For example, the second structure 22 is configured to have a reflectance to visible light of lower than 0.05%.

For example, the following model is applied to obtain the infinitesimal thickness of the microstructure 221 with a cone-like shape shown in FIG. 2:

(n₂²−1)/[1+0.5*(n₂²−1)]=p*n₁²/[1+0.5*(n₁²−1)].

The n₂ is the equivalent refractive index of the second structure 22, the n₁ is the refractive index of the first structure 21, and p is the filling density of the dielectric material in the second structure 22 in the space where it is located. The thickness and p of the second structure 22 may be adjusted by controlling the etching process that forms the second structure 22, so that n₂ may be adjusted, and the reflectance of the second structure 22 to visible light may be further adjusted. For example, the second structure 22 may be made as a broadband anti-reflective film with extremely low reflectance, such that the second structure 22 may not only minimize the influence of the light-transmitting protective film 20 on the optical properties of the optical element 10, but also can provide the anti-reflection effect that is difficult to achieve by a general anti-reflection coating.

For example, the second structure 22 may form a Cassie wetting state. For example, when water droplets adhere to the surface of the second structure 22 away from the first structure 21, air is still retained between the microstructures 221 of the second structure 22, so that the surface of the light-transmitting protective film forms a superhydrophobic state, providing the light-transmitting protective film with waterproof characteristics.

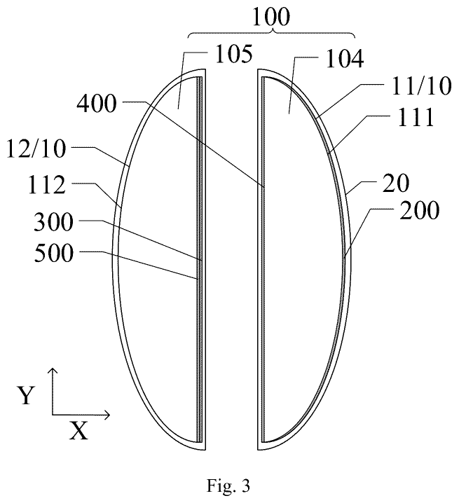

The embodiments of the present disclosure provide a method for manufacturing the light-transmitting protective film shown in FIG. 1 and FIG. 2, which adopts a plasma etching method to form a plurality of microstructures 221 in the light-transmitting protective film. Of course, the embodiments of the present disclosure are not limited thereto, and the manufacturing method is also applicable to the light-transmitting protective film in the optical structure shown in the subsequent FIG. 3.

For example, the plasma types include inductively coupled (ICP) plasma, capacitively coupled (CCP) plasma, bipolar plasma, radio frequency plasma, microwave plasma, or the like, the etching gases may include argon (Ar), krypton (Kr), xenon (Xe), helium (He), oxygen (O₂), hydrogen (H₂), nitrogen (N₂), carbon tetrafluoride (CF₄), hydrogen fluoride (HF), sulfur hexafluoride (SF₆), carbon hexafluoride (CF₆), or the like.

For example, after the optical element 10 shown in FIG. 2 is formed, a layer of Parylene C film may be uniformly deposited on the surface of the optical element 10 by chemical vapor deposition, with a water vapor transmission rate of 0.08 g·mm/(m²·24 h) and a deposition thickness of 500 nm. The surface of the Parylene C film exposed to air is oxygen etched by the inductively coupled (ICP) plasma to a depth of 120 nm to form the second structure 22 with the microstructures 221. When the porosity p of the microstructure 221 is 32%, the equivalent refractive index n₂ of the second structure 22 is 1.26, and the surface reflectance of the second structure 22 may be reduced to lower than 0.1%. At this time, the first structure 21 has a thickness of about 380 nm, and encloses the optical element 10 to protect it from moisture and oxygen, thereby preventing the failure of the lens structure 100, the transflective film 200, the linear polarizing film 500, and the adhesive layer in the optical element 10 caused by moisture absorption.

FIG. 3 is a cross-sectional schematic of an optical structure provided in another example according to the embodiment of the present disclosure. The lens structure 100 in the optical structure shown in FIG. 3 is different from the lens structure 100 in the optical structure shown in FIG. 1, and the phase retardation film 400, the reflective polarizing film 300, and the linear polarizing film 500 in the optical structure shown in FIG. 3 may have the same characteristics as the phase retardation film 400, the reflective polarizing film 300, and the linear polarizing film 500 in the optical structure shown in FIG. 1, which will not be described again here. The light-transmitting protective film 20 in the optical structure shown in FIG. 3 may have the same morphological characteristics as the light-transmitting protective film 20 shown in FIG. 2. For example, the light-transmitting protective film 20 includes the first structure 21 and the second structure 22 stacked with each other. The second structure 22 is exposed to air, the first structure 21 is in contact with the optical element 10, and the compactness of the first structure 21 is greater than that of the second structure 22. The second structure 22 includes a plurality of microstructures 221, where at least a part of the microstructures 221 have the pitch of the feature size in the direction parallel to a surface of the first structure 21 in contact with the optical element 10, and the feature size is not greater than the working wavelength of the optical element 10. The more detailed features in the light-transmitting protective film will not be described again here.

For example, as shown in FIG. 3, the lens structure 100 includes a lens 104 and a lens 105, a lens surface of the lens 104 facing the lens 105 and a lens surface of the lens 105 facing the lens 104 are flat, and a surface of the lens 104 away from the lens 105 and a surface of the lens 105 away from the lens 104 are convex. For example, an air gap is provided between the lens 104 and the lens 105. For example, the plane of the lens 105 close to the lens 104 is attached to the linear polarizing film 500 and the reflective polarizing film 300 though an OCA, the plane of the lens 104 close to the lens 105 is attached to the phase retardation film 400 through an OCA, and the surface of the lens 104 away from the lens 105 is coated with the transflective film 200.

For example, as shown in FIG. 3, the lens surface of the lens 104 away from the lens 105 is the first lens surface 111, the lens surface of the lens 105 away from the lens 104 is the second lens surface 112, the surface of the transflective film 200 away from the lens 105 is the first surface 11 of the optical element 10, and the second lens surface 112 is the second surface 12 of the optical element 10.

For example, as shown in FIG. 3, both lens 104 and lens 105 adopt the plasma-enhanced chemical vapor deposition (PECVD) method. Using HMDSO as the precursor, a dense amorphous silicon coating with alkyl groups is formed on the entire surface of lens 104 and lens 105 which are provided with the transflective film 200, the phase retardation film 400, the reflective polarization film 300 and the linear polarizing film 500. The thickness of the coating is 250 nanometers. Then, by using the ICP plasma etching method and a mixed gas of Ar, O₂ and CF₆, about 90 nanometers of the surface depth of the silicon coating is etched to form the second structure 22 with microstructures 221. The effective refractive index of the second structure 22 changes continuously. For example, it gradually decreases from the direction far from air to the direction close to air, and the surface reflectance can be less than 0.05%.

In addition to protecting the polymer with high water absorption rate and isolating moisture, the light-transmitting protective film 20 shown in FIG. 3 covers the convex surface of the lens 105 thereby improving abrasion resistance and dirt resistance and reducing reflection; covers the reflective polarizing film 300 on the plane of the lens 105, reducing the reflectance of the light transmitted through the transmittance axis of the reflective polarizing film 300, and improving the imaging contrast; covers the plane of the lens 104, reducing reflection and suppressing ghosting; and covers the convex surface of the lens 104, protecting the oxide material in the transflective film 200 from moisture absorption, and allowing the optical properties thereof be maintained by adjusting the film system.

The light-transmitting protective film covering the surface of the optical element provided in the present disclosure overcomes the defects of deteriorating the reflectance and transmittance of the optical element by a general high-performance waterproof coating, such as Parylene coating due to the high thickness.

Of course, the lens structure 100 in the optical structure provided in the present disclosure is not limited to including two lenses shown in FIG. 3 or three lenses shown in FIG. 1, but may also include one lens, four lenses or more lenses. The positional relationship between the transflective film 200, the phase retardation film 400, the reflective polarization film 300 and the linear polarizing film 500 and the lens structure 100 may be set as required.

FIG. 4 is a structural cross-sectional schematic of a part of a display apparatus provided in another embodiment of the present disclosure.

As shown in FIG. 4, the display apparatus includes an optical structure provided by any one of the above embodiments of the display screen 30. The optical structure schematically shown in FIG. 4 is the optical structure shown in FIG. 1, but is not limited thereto, and may also be the optical structure shown in FIG. 3.

As shown in FIG. 4, the optical structure is positioned at the display side of the display screen 30, and the second surface 12 of the optical element 10 is provided on a side of the first surface 11 away from the display screen 30.

For example, as shown in FIG. 4, the display surface of the display screen 30 is provided in the focal plane of the light incident side of the optical structure.

For example, as shown in FIG. 4, the display screen 30 may be any type of display screen 30, such as a liquid crystal display 30, an inorganic light-emitting diode display screen 30, a quantum dot display screen 30, a projector (such as LCOS micro projector), and the like.

For example, as shown in FIG. 4, the display screen 30 may be a silicon-based organic light-emitting diode display screen with extremely high pixel density, and the optical structure has the performance of high definition and large field of view, and the diffuse spot of the optical structure in the central field of view is lower than the size of one sub-pixel (micron level), and the full field of view may exceed 100 degrees.

For example, the display apparatus may be a virtual reality (VR) display apparatus. For example, the virtual reality display apparatus may be a display apparatus with an ultra-short throw folded optical path.

For example, the display apparatus may be a near-eye display apparatus, and the near-eye display apparatus may be a wearable VR helmet, VR glasses, and the like, and the embodiments of the present disclosure are not limited thereto.

The following statements should be noted:
(1) In the accompanying drawings of the embodiments of the present disclosure, the drawings involve only the structure(s) in connection with the embodiment(s) of the present disclosure, and other structure(s) can be referred to common design(s).
(2) In case of no conflict, features in one embodiment or in different embodiments can be combined.

What have been described above are only specific implementations of the present disclosure, the protection scope of the present disclosure is not limited thereto, and the protection scope of the present disclosure should be based on the protection scope of the claims.

1. An optical structure, comprising:
an optical element, comprising a first surface and a second surface opposite to each other;
a light-transmitting protective film, between the optical element and air, and the light-transmitting protective film is at least in contact with at least one of the first surface and second surface,
wherein the optical element comprises a lens structure and a transflective film, a reflective polarizing film, and a phase retardation film provided on the lens structure, the lens structure comprises a first lens surface and a second lens surface respectively provided on a light incident side and a light exiting side of the lens structure, at least one of the first lens surface and the second lens surface is a curved surface, both the reflective polarizing film and the phase retardation film are provided on a side of the transflective film facing the second lens surface, the first surface and the second surface comprise at least one of the group consisting of a surface of the transflective film, a surface of the phase retardation film, a surface of the reflective polarizing film, the first lens surface and the second lens surface;
the light-transmitting protective film comprises a first structure and a second structure stacked with each other, the second structure is in contact with the air, and the first structure is in contact with the optical element, a compactness of the first structure is greater than a compactness of the second structure, the second structure comprises a plurality of microstructures, and at least part of the microstructures have a pitch of a feature size in a direction parallel to a surface, of the first structure, in contact with the optical element, and the feature size is not greater than a working wavelength of the optical element.

2. The optical structure according to claim 1, wherein a water vapor transmission rate of the first structure is ≤1 g·mm/(m²·24 h).

3. The optical structure according to claim 1, wherein the feature size is 10 nm to 300 nm.

4. The optical structure according to claim 1, wherein an average thickness of the light-transmitting protective film is 50 nm to 10 μm.

5. The optical structure according to claim 1, wherein an average thickness of the second structure is 20 nm to 300 nm.

6. The optical structure according to claim 1, wherein a refractive index of the first structure is greater than an equivalent refractive index of the second structure, and the refractive index of the first structure is 1.4 to 2.5, and the equivalent refractive index of the second structure gradually decreases in an arrangement direction of the first structure towards the second structure.

7. The optical structure according to claim 6, wherein a size of each microstructure in a direction parallel to the surface of the first structure in contact with the optical element is a cross-sectional size, and in the arrangement direction, the at least a part of the microstructures have decreasing cross-sectional sizes.

8. The optical structure according to claim 7, wherein the at least part of the microstructures have a shape of a circular truncated cone or a cone.

9. The optical structure according to claim 1, wherein a material of the light-transmitting protective film comprises one or more of parylene and its various substituted derivatives, hexamethyldisiloxane, polytetrafluoroethylene, acrylic acids, and fluorosilanes.

10. The optical structure according to claim 1, wherein the second structure in the light-transmitting protective film is configured to have a reflectivity to visible light of lower than 0.2%.

11. The optical structure according to claim 1, wherein the light-transmitting protective film completely encloses the optical element.

12. The optical structure according to claim 1, wherein the first structure and the second structure are integrally arranged.

13. The optical structure according to claim 1, further comprising: a linear polarizing film, on a side of the reflective polarizing film away from the transflective film.

14. The optical structure according to claim 13, wherein the second surface comprises a surface of the linear polarizing film.

15. The optical structure according to claim 5, wherein an average thickness of the first structure is greater than the average thickness of the second structure.

16. The optical structure according to claim 1, wherein the feature size is 10 nm to 300 nm, a refractive index of the first structure is greater than an equivalent refractive index of the second structure, and an average thickness of the light-transmitting protective film is 50 nm to 10 μm.

17. The optical structure according to claim 3, wherein the second structure in the light-transmitting protective film is configured to have a reflectivity to visible light of lower than 0.2%.

18. The optical structure according to claim 1, wherein the light-transmitting protective film completely encloses the optical element, and the first structure and the second structure are integrally arranged.

19. A display apparatus, comprising a display screen and the optical structure according to claim 1,
wherein the optical structure is provided on a display side of the display screen, and the second surface is provided on a side of the first surface away from the display screen.

20. A method for manufacturing the optical structure according to claim 1, comprising:
forming the plurality of microstructures in the light-transmitting protective film through plasma etching.
